(19) United States
(12) Patent Application Publication
(10) Pub. No.: US 2008/0308692 A1
(43) Pub. Date: Dec. 18, 2008

(54) Support with Detachable Footrests

(76) Inventors: Fu-yuan CHENG, Taichung (TW); Chien-Chou Lin, Taichung (TW)

Correspondence Address: Dr. BANGER SHIA, 102 Lindencrest Ct., Sugar Land, TX, 77479-5201, US

(21) Appl. No.: 11/764,200

(22) Filed: Jun. 16, 2007

(51) Int. Cl. F16M 11/20

(52) U.S. Cl. 248/188.8

(57) ABSTRACT

A support with detachable footrests comprises a body and two footrests. The two footrests are detachably assembled on the body. When the support is stored, the two footrests can be detached from the body, and then inserted into both sides of the body, thus greatly reducing the storage space.

### BACKGROUND OF THE INVENTION

1. Field of the Invention

The present invention relates to a support, and more particularly to a support with detachable footrests.

2. Description of the Prior Art

As shown in FIG. 1, a conventional support usually comprises a body 10 and two footrests 20 that are integrally formed, no matter it is fixed or movable ones, and no matter it is used on the cart, stretcher or the hammock. If the weight of the hanging object is relatively great, the length of the two footrests 20 should be increased to make the support much more steady.

However, under the current condition that the land is worth its weight in gold, the two footrests 20 of this support occupy too much storage space, so it is difficult to find space for storage. If the footrests 20 are lengthened, it will cause the storage much more inconvenient.

The problem of the existing support is that its footrests 20 occupy great space. Hence, in order to effectively solve the conventional problem of the support, the applicant of the present invention has developed a support with detachable footrests from the body 10 integral with the two footrests 20.

The present invention has arisen to mitigate and/or obviate the afore-described disadvantages.

### SUMMARY OF THE INVENTION

The primary objective of the present invention is to provide a support with detachable footrests whose footrests can be detachably assembled on the body of the support for saving the storage space and facilitating the storage.

The second objective of the present invention is to dispose inserting grooves on the body for the insertion of the footrests which have been detached from the body, thus facilitating the footrest storage.

In order to achieve the first objective, the support with detachable footrests comprises a body and at least two footrests. Each footrest is detachably assembled on the body, so that when the support is stored, the footrests can be detached from the body for saving the storage space.

In order to achieve the second objective, the body is disposed with at least two inserting grooves for the footrests. Each inserting groove is disposed on the periphery of the body. The two inserting grooves are provided for the insertion of the two footrests which have been detached form the body, so as to facilitate the storage of the two footrests.

Moreover, the two footrests can be locked on the body by screw for facilitating disassembling the two footrests from the body.

Two screws can be used to lock each footrest on the body, thus having the advantages of firmly-positioning and material-saving.

### BRIEF DESCRIPTION OF THE DRAWINGS

FIG. 1 is a perspective view of a conventional footrest integral with a body;

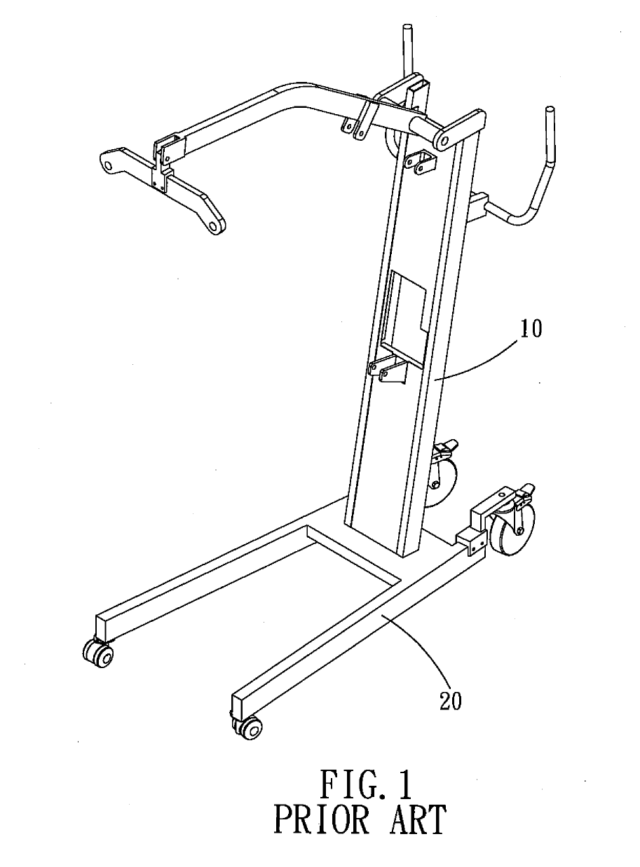

FIG. 2 is an exploded view of a support with detachable footrests in accordance with the prevent invention;

FIG. 3 is a perspective view of the support with detachable footrests in accordance with the prevent invention;

FIG. 4 shows that the footrests are locked on the body by screw in accordance with the present invention; and

FIG. 5 shows that the footrests are inserted into the inserting grooves in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

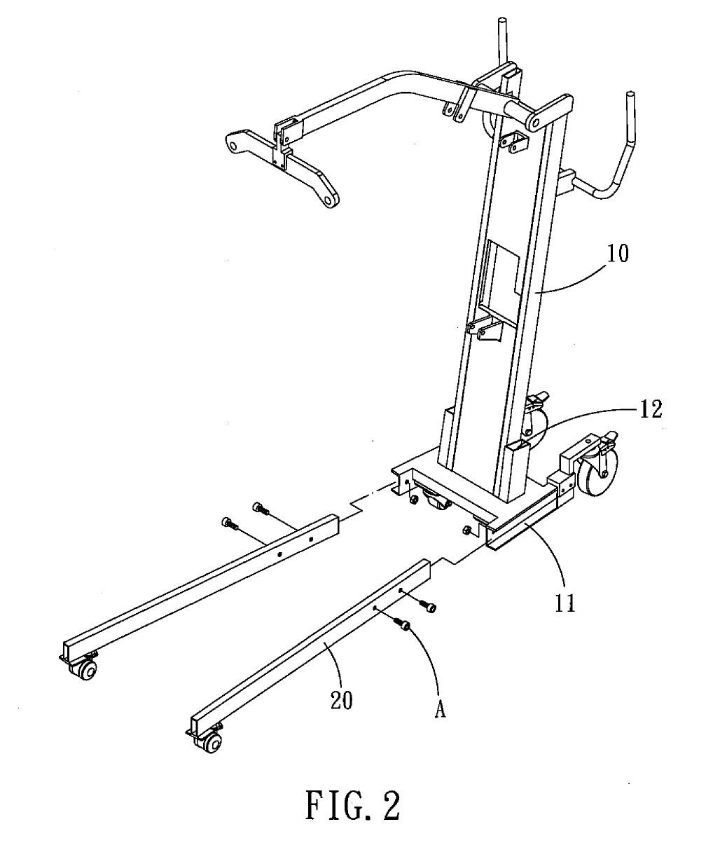

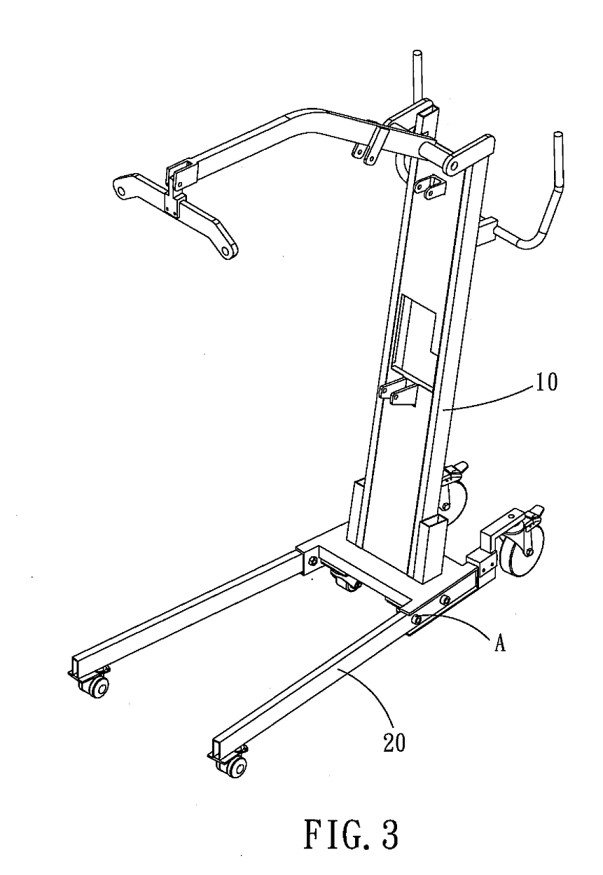

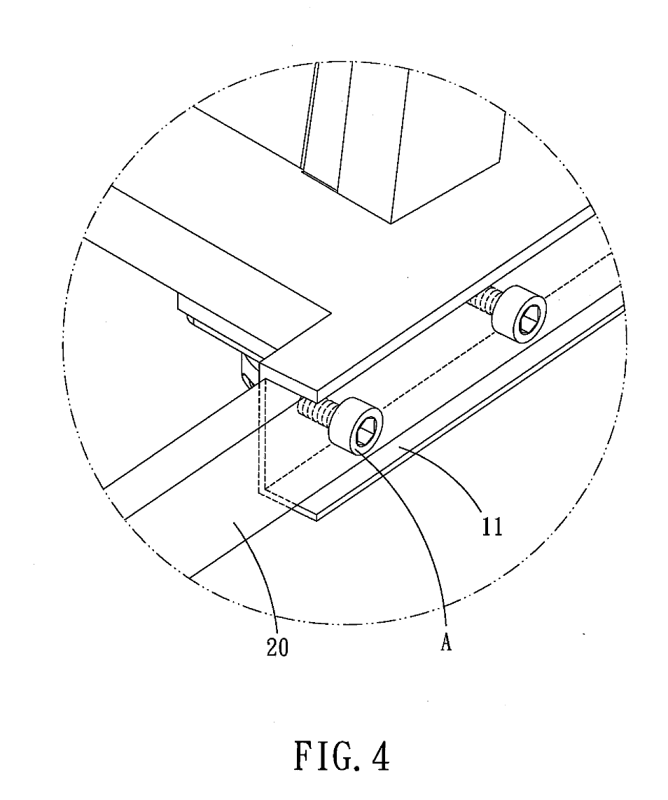

Referring to FIGS. 2-4, a support with detachable footrests in accordance with a preferred embodiment of the present invention can be used on a cart, a stretcher or a hammock and comprises a body 10, and two footrests 20.

The body 10 is disposed with a concave portion 11 at each side of one end thereof, and at each side of the body 10 is disposed an inserting groove 12. Each inserting groove 12 is opened in an opposite direction of each concave portion 11.

One end of each footrest 20 is detachably assembled in each concave portion 11 of the body 10, in this embodiment, the two footrests 20 are locked in the concave portions 11 through two screws A respectively.

Hence, when storing the support, simply by dissembling the two screws A from the footrests 20, the footrests 20 can be taken out from the two concave portions 11 of the body 10, thus reducing the occupied space.

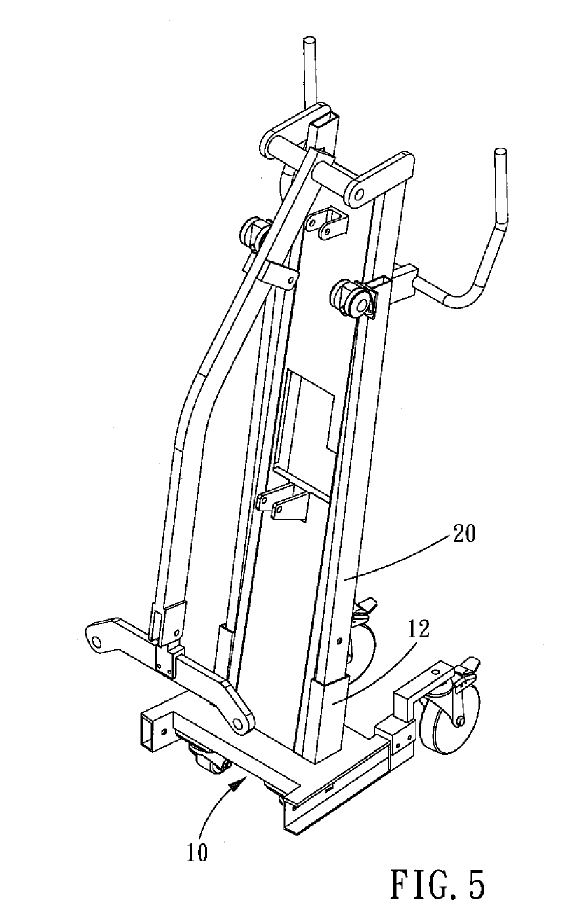

Further referring to FIG. 5, each of the two footrests 20 can be inserted into the two inserting grooves 12 of the body 10, so as to facilitate the storage of the two detached footrests 20.

As known form the abovementioned, the support with detachable footrests of the present invention achieves the objective of saving the storage space by detachably assembling the two footrests 20 on the body 10.

Further, each side of the body 10 is disposed with an inserting groove 12 for an insertion of each footrest 20, which has been detached from the body 10, thus facilitating the storing operation of the two footrests 20.

Additionally, each footrest 20 can be locked on the body 10 by two screws A. The footrests 20 require to be positioned firmly and save material during the assembling operation, so each footrest 20 is fixed by two screws A, so as to use the minimum materials to achieve the objective of firm-positioning without rotation.

While we have shown and described various embodiments in accordance with the present invention, it is clear to those skilled in the art that further embodiments may be made without departing from the scope of the present invention.

What is claimed is:

1. A support with detachable footrests comprising a body and at least two footrests; wherein:
one end of the body is disposed with at least two concave portions, on a periphery of the body is disposed at least two inserting grooves; and
one end of each footrest is detachably assembled in each concave portion of the body, the end of each footrest which is assembled with the body will be inserted into each inserting groove.

2. The support with detachable footrests as claimed in claim 1, wherein each inserting groove is opened in an opposition direction of each concave portion.

3. The support with detachable footrests as claimed in claim 1, wherein each footrest is locked in each concave portion by screw.

4. The support with detachable footrests as claimed in claim 3, wherein each footrest is locked in each concave portion by two screws.
